(19) United States
(12) Patent Application Publication
(10) Pub. No.: US 2025/0282644 A1
(43) Pub. Date: Sep. 11, 2025

(54) FILTER FOR REMOVING MICROSCALE OR NANOSCALE PLASTIC PARTICLES FROM WATER, AND WATER-TREATMENT DEVICE

(71) Applicant: KLAR2O GMBH, Bruchsal (DE)

(72) Inventor: Fähzan AHMAD, Bruchsal (DE)

(21) Appl. No.: 18/861,409

(22) PCT Filed: Apr. 26, 2023
(86) PCT No.: PCT/EP2023/060968

§ 371 Date: Oct. 29, 2024

(30) Foreign Application Priority Data
Apr. 29, 2022 (LU) LU501978

(51) Int. Cl. C02F 1/00; C02F 1/58

(52) U.S. Cl. CPC C02F 1/001; C02F 1/58

(57) ABSTRACT

The invention relates to a filter (1) for removing microscale or nanoscale plastic particles (6) from water, comprising a filter material (3; 3a) through which the water can flow. The filter medium (3; 3a) expediently comprises spheres (4, 5, 14-17; 4a, 5a, 14a-17a), wherein the spheres (4, 5, 14-17; 4a, 5a, 14a-17a) have a coating (7) which is designed for absorbing the plastic particles (6), and wherein the spheres (4, 5, 14-17; 4a, 5a, 14a-17a) are arranged in a bidisperse sphere packing. Arranging the coated spheres in a bidisperse sphere packing advantageously makes it possible to obtain a particularly high packing density and also to set a particularly high rate of flow through the filter.

The invention relates to a filter for removing micro- or nanoscale plastic particles from water, which contains a filter medium through which the water can flow. The invention also relates to a water treatment device, in particular for removing micro- or nanoscale plastic particles from water.

Nanoscale plastic particles have a particle size between 1 nm and 100 nm, while microscale plastic particles can have a particle size between >100 nm and <35 μm. Such nano- or microscale plastic particles contain in particular polyethylene (PE), polypropylene (PP) or polyethylene terephthalate (PET) and may be absorbed by living beings via drinking water and accumulate in their bodies, especially in the internal organs as well as in the blood and brain, and lead to severe health problems. For example, they can cause inflammations of the vascular wall of the aorta in humans (see e. g. https://journals.plos.org/plosone/article?id=10.1371/journal.pone.0260181, most recently accessed on Apr. 19, 2023) or the stretching and rupture of a cell membrane (see e. g. https://www.pnas.org/doi/10.1073/pnas.2104610118, most recently accessed on Apr. 19, 2023).

Water filters for treating drinking water are known. They remove in particular limescale and ions from tap water. Activated carbon filters are also known for purifying water contaminated with bacteria.

Other filters are mentioned in CN 108 926 880 A, US 2006/0260997 A1 and U.S. Pat. No. 6,361,710 B1.

DE 10 2020 132 439 A1 mentions a filter with a filter medium whose hydrophobic layer is intended to absorb micro- or nanoscale plastic particles. In this printed document, a pressurized water treatment device is also mentioned. However, in the case of nano- or microscale plastic particles, either high pressures are required or a long processing time is necessary in order to achieve a satisfactory filter performance.

The primary object of the present invention is to create a filter of the aforementioned type that overcomes the disadvantages of previous filters.

According to this invention, this object is achieved in that the filter medium contains spheres with a layer which is designed to capture the plastic particles and that the spheres are located in a bidisperse sphere packing.

The term capture refers to sorption, namely absorption or adsorption, in particular adsorption, namely adhesion to the layer that partially, preferably completely, covers the surface of a sphere.

For the purpose of this invention, a sphere is a body that can deviate from a perfect spherical shape within the scope of technical production tolerances. For example, an ellipsoid could be considered a sphere for the purpose of this invention, it its smallest and largest radius do not deviate from each other by more than 4%.

A bidisperse sphere packing is a sphere packing in which spheres of a first size are mixed with spheres of a second size. The size of the spheres can be determined in particular by their diameter. For the purpose of this invention, a bidisperse sphere packing only contains spheres of a first size and spheres of a second size, whereby production tolerances are taken into account. In contrast to a bimodal distribution, a bidisperse sphere packing does not contain any spheres whose size lies between the size of the first and the size of the second spheres, whereby production tolerances are taken into account for the purpose of this invention. This would pose a disadvantage, because spheres of an intermediate size would occupy interstices in the filter, which would significantly reduce the flow through the filter. The possible throughput, namely the flow rate, would drop significantly.

An example for a bidisperse sphere packing is a mixture of spheres with a diameter of 3 mm and of spheres with a diameter of 1 mm. The advantage of a bidisperse sphere packing is that a very high packing density can be achieved, whereby the interstices between larger spheres are occupied by smaller spheres. This also allows for a very large specific surface to which the plastic particles to be removed from the treated water can adhere. A filter with an optimal filtration performance can effectively be produced by using a bidisperse sphere packing.

The spheres of a first size from the bidisperse sphere packing may be used to remove a first type of plastic particles from the water, while spheres of a second size from the bidisperse sphere packing are designed to remove a second type of plastic particles. This is in particular possible by using different coating materials. For example, the spheres of the first size may be designed to remove polypropylene (PP) and the spheres of the second size may be designed to remove polymethyl methacrylate (PMMA).

The spheres may also be positioned in a multi-disperse sphere packing. A tridisperse sphere packing would require spheres of three different sizes and a tetradisperse sphere packing would require spheres of four different sizes.

In addition, the invention also aims at creating a water treatment device that can be operated in the water supply network of a building, for example at a faucet in a kitchen or residential building. Typical water pressures range between 2 and 6 bar in buildings and are sufficient for removing plastic particles. At the same time, a water treatment device that can be operated in the water supply network of a building at the usual volume flows that range between 5 and 15 l/min shall also be produced.

This problem is solved by a water treatment device according to the invention.

The inventor has realized that filter properties can be customized by an appropriate selection of the parameters of the spheres located in the bidisperse sphere packing, in particular their diameter or their filter medium volume fraction.

In particular, both a very high packing density and a high flow rate through the filter may be achieved.

In can also be effectively ensured that a very high filtration performance is achieved, meaning that a very large number of plastic particles are removed. In particular, this is made possible by the vary large specific surface area of the filter medium, namely the surface area of all coated spheres located in the bidisperse sphere packing that is available to absorb plastic particles from the water to be purified.

The spheres may be hollow or solid.

For this purpose, the packing density of the spheres shall range between 55 and 90 vol %, preferably between 65 and 80 vol % and more preferably between 71 and 76 vol %. The volume percentage refers to the entire volume of the filter medium. For example, a volume percentage (vol %) of 90 means that 90% of the filter medium volume is occupied by spheres and 10 vol % is the space through which the water to be treated can flow. The aforementioned volume fractures enable both a very high flow rate through the filter and a minimal pressure loss between the inlet and the outlet.

In an embodiment of the invention, the ratio k_{d} of a first diameter d₂ to a second diameter d₁ of the spheres ranges between 0.10 and 0.35, preferably between 0.20 and 0.31.more preferably 0.3. The ratio k_{d} is defined as the quotient of the diameter de of the second type of spheres and the diameter d₁ of the first type of spheres, whereby d₁ >d₂. If k_{d} is given and the first diameter d₁ is set, the second diameter d₂ can be determined by multiplying d₁ by k_{d}.

It goes without saying that k_{d} can never be equal to 1, as otherwise a bidisperse sphere packing would not exist.

The inventor has realized that if the ratio k_{d} is less than 0.10, the flow through a filter according to the invention may fall below a flow value at which, for example, the use of an unpressurized filter is still be possible.

If the ratio k_{d} is greater than 0.35, the flow through the filter increases, but the filter performance decreases because the total surface of the spheres is no longer sufficient to absorb the micro- or nanoscale particles from the water.

The inventor has discovered that a ratio k_{d}=0.3 creates a particularly powerful filter with a high flow rate and a high purification performance.

In a further embodiment of the invention, the diameter d₁ of the spheres is greater than the diameter d₂ of the spheres and ranges between 0.95 and 1.05 mm, preferably between 0.98 and 1.02 mm, most preferably is 1.00 mm. This diameter value of the first type of the spheres located in the bidisperse sphere packing has proven to be particularly effective in producing a sufficiently large specific surface area of the filter medium on which almost all plastic particles from the water to be purified can be adsorbed.

In an embodiment of the invention, the ratio kₚ of a volume fraction p₂ of the spheres in a total sphere volume in the filter medium to a volume fraction p₁ of the spheres in a total sphere volume in the filter medium ranges between 0.4 and 0.9, preferably between 0.45 and 0.70, most preferably between 0.49 and 0.61. The ratio kₚ is defined as the quotient of the volume fraction p₂ of the second type of spheres (with diameter d₂) and the volume fraction p₁ of the first type of spheres (with diameter d₁), whereby p₁+p₂=1. The volume fraction refers to the proportion of spheres with diameter d₁ and the proportion of spheres with diameter d₂ in relation to the total sphere volume in the filter medium.

For example, a ratio kₚ of 0.5 would mean that the spheres with the diameter d₁ have twice as large a volume fraction p₁ as the spheres with the diameter d₂, whose volume fraction is p₂. This means that two thirds of the total sphere volume in the filter medium consists of spheres with the diameter d₁.

The inventor has determined that a very economical filter is produced within the aforementioned range.

For this purpose, the length of the filter medium in the direction of the flow through the filter is between 3 and 12 cm, preferably between 4 and 10 cm, most preferably 8 cm or 9 cm. Tests and flow simulations have revealed that a filter medium with such a length has a very good purification performance. If the filter medium has a length of 9 cm, almost all plastic particles with a size between 1 nm and 10 μm could be removed from the water, while at a length of 8 cm, almost all plastic particles with a size between 10 μm and 30 μm could be removed from the water. The purification performance can be customized through the length of the filter medium. The advantage of a filter according to the invention is its versatility.

In a further embodiment of the invention, the volume flow at which water can flow through the filter ranges between 4 and 15 l/min, preferably between 7 and 12 l/min. Effective everyday use without the need for additional pressurization is therefore possible. In particular, the invention may be used at home in everyday life to purify drinking water.

In a further embodiment of the invention, the spheres contain a material whose surface can be activated, preferably silicon dioxide. In addition to silicon dioxide (SiO₂), technical ceramics can also be used, in particular zirconium dioxide (ZrO₂) or aluminum oxide (Al₂O₃). Preferably, the spheres should however be made of SiO₂.

Depending on the material, silanol and/or hydroxide groups are formed by activating the surface, which bond extremely well with the coating material. This effectively ensures that the coating material, in particular one made of plastic, does not peel off. The surface may be activated, for example, by a so-called piranha solution (peroxomonosulfuric acid; 3 parts concentrated sulfuric acid and 1 part 30% by weight hydrogen peroxide solution) or by plasma, for example by so-called plasma etching.

For this purpose, the layer shall be made of a hydrophobic or hydrophilic material. In particular, a hydrophobic or hydrophilic material from the group consisting of trichlorosilane, cellulose, polyamide and polyethylene glycol should be selected. The layer can also be made of a material which has an electrical dipole moment and is part of the group consisting of polytetrahydrofuran, polymethyl methacrylate and a zeolite.

Preferably, the trichlorosilane should be octadecyltrichlorosilane. A layer that contains trichlorosilane, in particular octadecyltrichlorosilane (OTS), is hydrophobic and suitable for absorbing nano- or microscale plastic particles.

A layer that contains cellulose, polyamide and/or polyethylene glycol (PEG) is hydrophilic. Hydrogen bonds can be formed between the layer and the plastic particles in order to absorb the plastic particles. In particular, polyurethane (PU), polycarbonate (PC), polyamide (PA), polyvinyl chloride (PVC), phenolic resins, polymethyl methacrylate (PMMA) and polypropylene (PP) may be removed from drinking water through a hydrophilic layer.

It is conceivable that the layer is made of a material that has a permanent electric dipole moment, preferably tetrahydrofuran and/or a natural zeolite. It is also conceivable that the layer is formed as a carbon molecular sieve. The zeolite may be natural or synthetic. If the layer contains a material with a permanent electric dipole moment, polyurethane (PU), polycarbonate (PC) and polyamide (PA) can be removed particularly easy from drinking water.

In an embodiment of the invention, the layer is made of a material that has a permanent dipole and is designed to induce a dipole in a non-polar plastic particle, preferably acetone and/or polymethyl methacrylate (PMMA).

If the layer contains a material with a permanent dipole, polymethyl methacrylate (PMMA), polyamide (PA) and polypropylene (PP) can be removed particularly easy from drinking water.

For this purpose, the layer contains a material which has a conjugated π-system and is preferably selected from the group consisting of activated carbon, graphene, organic zeolites and polycyclic aromatic hydrocarbons.

In particular, the polycyclic aromatic hydrocarbons are selected from the group consisting of naphthalene, anthracene, benzopyrene, acenaphthylene, acenaphthene, fluorene, phenanthrene, fluoranthene, pyrene, benzanthracene, coronene, ovalene, tetracene, pentacene, chrysene, perylene, benzo[a]fluoranthene, benzo[j]fluoranthene, pentaphene, hexacene, heptaphene, heptacene, trinaphthylene and superphenalene. The use of mesitylene and xylene is also conceivable.

In particular, polyethylene terephthalate (PET), polybutylene terephthalate (PBT), polyethylene naphthalate (PEN) or polystyrene (PS) can be removed from water through a layer that contains a conjugated π-system.

In an embodiment of the invention, the layer is made of a hydrophobic or hydrophilic material selected from the group consisting of cellulose, polyamide and polyethylene glycol, or the layer is made of a material that has an electrical dipole moment and is selected from the group consisting of polytetrahydrofuran, polymethyl methacrylate and a zeolite and/or the layer contains a material that has a conjugated π-system. The inventor has realized that although a hydrophobic layer that contains trichlorosilane is suitable for absorbing nano- or microscale plastic particles, a better absorption of the nano- or microscale plastic particles is possible with another of the aforementioned coatings. A filter with a 3 to 10% higher filter performance can effectively be produced, if a coating material other than the one containing trichlorosilane is used.

In an embodiment of the invention, the filter medium consists of several sections that are arranged one behind the other in the direction of the flow through the filter, whereby each section is designed to remove certain plastic particles from the water.

A single filter that can be used universally to remove various plastic particles from drinking water poses an advantage. This applies in particular to filters that are intended for domestic use.

The adjacent sections may have the same configuration with regard to sphere sizes, i. e. the bidisperse sphere packing. This means that they may have the same fluid mechanical properties and that the spheres from the individual sections only differ from one another through their coating.

The individual sections may also have different fluid mechanical properties. For example, the first section may contain a bidisperse sphere packing with a lower packing density than a second, adjacent section.

The diameters d_{1,1} and d_{2,1} of the spheres from a first section may also differ from the diameters d_{1,2} and d_{2,2} of the spheres from a second, adjacent section.

The same applies to the ratio k_{d} of the sphere volume fractions p_{1,1}, p_{1,2} and p_{2,3}, p_{2,2} as well as the ratio k_{d} of the sphere diameters d_{1,1}, d_{1,2} and d_{2,1}, d_{2,2}.

For example, a first section may be designed to remove polyethylene particles (PE) and a second section may be designed to remove polymethyl methacrylate particles (PMMA).

Each section may also contain different types of spheres, which differ both through their size and their coating material. For example, the first type of spheres from the bidisperse sphere packing may be designed to remove a first type of plastic particles, while the second type of spheres from the bidisperse sphere packing of the same section may be designed to remove a second type of plastic particles.

A filter according to the invention and a water treatment device according to the invention may therefore be effectively customized for specific applications.

For this purpose, the filter material has rotational symmetry, preferably a cylindrical shape, and allows flow in axial direction. Border effects that reduce the filtration performance are effectively minimized or prevented thereby.

In a further embodiment of the invention, the spheres from adjacent sections are coated with different layers. The spheres from each section have a bidisperse sphere packing and are covered with a layer that is designed to absorb a specific type of plastic particles. For example, the spheres from the first section may be coated with a layer that contains a material with an electrical dipole moment, while the spheres from the second section are coated with a layer that contains a hydrophobic material and the spheres from the third section are coated with a layer that contains a hydrophilic material.

A universal filter with a high filtration performance can thus effectively be produced. For this purpose, the water treatment device, in particular for removing micro- or nanoscale plastic particles, contains a filter according to one of the claims 1 to 12.

In an embodiment of the invention, the water treatment device can be operated by gravitational pressure or by the line pressure of a water pipe. Operation by gravitational pressure means that water from which plastic particles are to be removed can flow through the filter medium due to gravity in a water column located above a filter. The inventor used a filter medium that contains a bidisperse sphere packing of coated spheres to produce a filter that can almost completely remove nano- or microscale plastic particles from drinking water without high pressure despite their small size, so that a water treatment device according to the invention can effectively be operated using the line pressure of the water pipes from a building. For example, a filter cartridge with a filter according to the invention can be mounted on a kitchen faucet and used to purify tap water.

The invention is explained in more detail using embodiments and the enclosed drawings related to the embodiments. They represent:

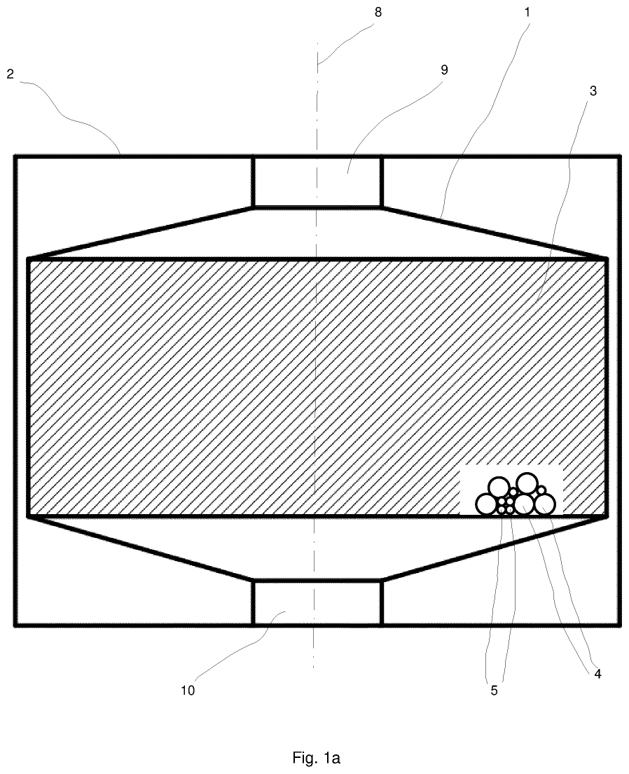

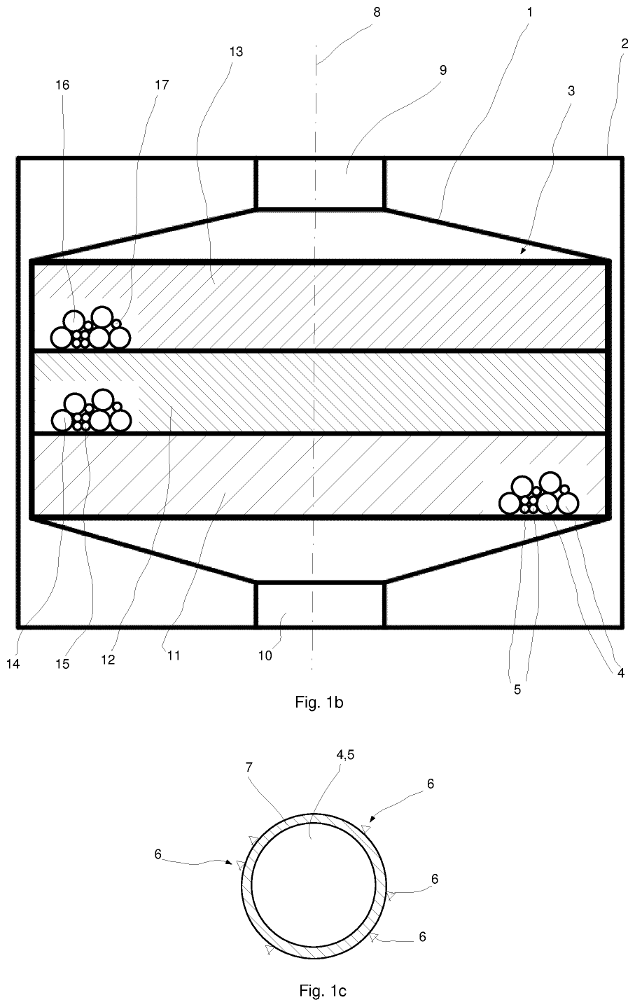

FIG. 1 A water treatment device according to the invention with several embodiments of a filter according to the invention,

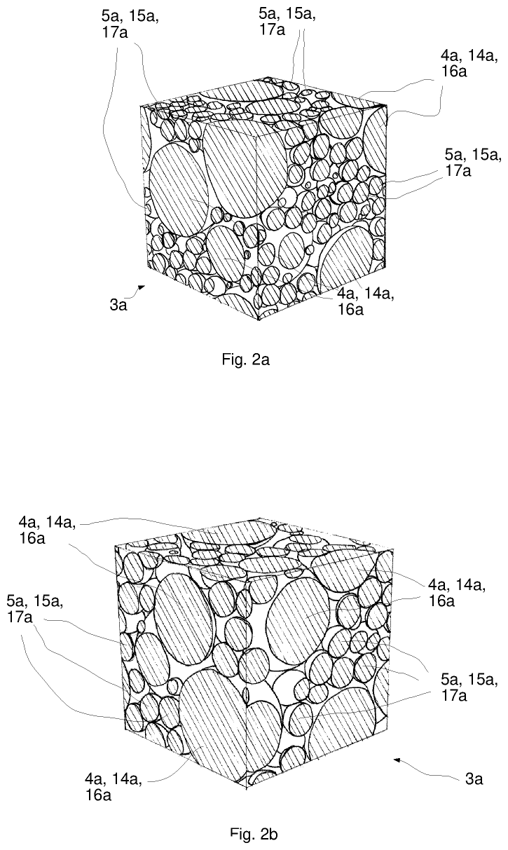

FIG. 2 Details of a filter according to the invention.

FIG. 1a represents a schematic longitudinal section of a filter 1 of a water treatment device 2 which can be mounted on a faucet that is not shown in FIG. 1. The filter contains a cylindrical filter medium 3, which is made of the SiO₂ spheres shown in detail in FIG. 1c, that are located in a bidisperse sphere packing and are coated with layer 7 that absorbs plastic particles 6. For the sake of clarity, only some spheres 4, 5 of the filter medium are shown in FIG. 1a and not all of them have a reference sign. The spheres 4 have the diameter d₁, while the spheres 5 have the diameter d₂.

Water can flow into filter 1 through an inlet channel 9 that extends coaxially to cylinder axis 8 and can flow out of the filter 1 through an outlet channel 10 that extends coaxially to the cylinder axis after passing through the filter medium.

The length of the filter medium is 9 cm in the flow direction.

FIG. 1b represents a schematic longitudinal section of a filter 1 that differs from the filter shown in FIG. 1 in that the filter medium 3 consists of three sections 11, 12, 13. The sections contain the coated SiO₂ spheres 4, 5, 14, 15, 16, 17 located in a bidisperse sphere packing, whereby the layer of spheres 4, 5 contains a different material than the layer of spheres 14, 15, and this in turn contains a different material than the layer with which spheres 16, 17 are coated. All sections 11, 12, 13 are inserted into a single filter housing which does not have a reference sign.

A filter according to FIG. 1b can effectively remove various micro- or nanoscale plastic particles.

In an embodiment according to FIG. 1b, the SiO₂ spheres 4, 5 of section 11 are coated with a layer that contains polyamide, while the SiO₂ spheres 14, 15 of section 12 are coated with a layer that contains polyethylene glycol (PEG). The SiO₂ spheres 16, 17 of section 13 are coated with polymethyl methacrylate (PMMA).

A water treatment device 2 with a filter 1 is produced, which is particularly suitable for removing polyurethane (PU), polypropylene (PP) and polymethyl methacrylate (PMMA) from drinking water.

Section 13 may contain SiO₂ spheres that are coated with activated carbon.

Although the spheres 4, 14, 16 and the spheres 5, 15, 17 have the same size in this embodiment, this is not required.

Spheres 4, 5 from section 11 may have two diameters d_{11,1} and d_{11,2} that differ from diameters d_{12,1} and d_{12,2} of spheres 14, 15 from section 12 and these in turn differ from diameters d_{13,1} and d_{13,2} of spheres 16, 17 from section 13.

The SiO₂ spheres 4, 5 from section 11 may also be coated with different layers. The same applies to the SiO₂ spheres 14,15 from section 12 as well as the SiO₂ spheres 15, 17 from section 13.

For the sake of clarity, only some spheres 4, 5, 14-17 of filter medium 3 are shown in sections 11-13.

To produce the filter 1 with a filter medium 3 according to FIG. 1b, the sections 11-13 are filled one after the other with the corresponding bidisperse sphere mixtures in a housing of filter 1, which does not have a reference sign in FIG. 1.

It goes without saying that further sections can be added in which, for example, known filter materials are used, in particular activated carbon. It should preferably have a spherical shape and be located in a bidisperse sphere packing.

Reference is now made to FIG. 2, where identical or equivalent parts have the same reference numbers as in FIG. 1 and the relevant reference numbers are always followed by the letter a.

Table 1 shows three suitable filter media 3₁, 3₂ and 3₃ with bidisperse sphere packings as well as their flow properties in relation to sphere parameters. Details of filter media 3₂ and 3₃ are shown in FIGS. 2a and 2b.

TABLE 1
Properties of three suitable filter media

| | | | | | | | Packing | Specific | Volume |
|---|---|---|---|---|---|---|---|---|---|
| Filter | d₁ | d₂ | p₁ | p₂ | | | density | surface area | flow |
| medium | (mm) | (mm) | (%) | (%) | k_{d} | kₚ | (vol %) | (m²/m³) | (l/min) |
| 3₁ | 3.0 | 0.450 | 0.625 | 0.375 | 0.150 | 0.60 | 75 | 4572.6 | 3.63 |
| 3₂ | 3.0 | 0.675 | 0.625 | 0.375 | 0.225 | 0.60 | 74 | 3305.5 | 5.71 |
| 3₃ | 3.0 | 0.900 | 0.667 | 0.333 | 0.300 | 0.50 | 72 | 2548.9 | 8.56 |

Meaning:
d₁: Diameter of the larger spheres (4, 14, 16 in FIG. 1)
d₂: Diameter of the smaller spheres (5, 15, 17 in FIG. 1)
p₁: Volume fraction of the larger spheres to the total sphere volume
p₂: Volume fraction of the smaller spheres to the total sphere volume
k_{d}: Ratio d₂ to d₁
kₚ: Ratio p₂ to p₁
Packing density: Volume fraction of the spheres to the total volume of the filter medium
Specifical surface area: Total surface area of spheres 4, 5, 14-17 in the filter medium
Volume flow: Volume flow through the filter medium during water treatment

FIG. 2a shows a section of the filter medium 3ₐ in perspective view. The filter medium is designed according to configuration 2, namely filter medium 3₂ from table 1.

FIG. 2b shows a section of the filter medium 3ₐ in perspective view. The filter medium is designed according to configuration 3, namely filter medium 3₃ from table 1.

Hatched areas in FIG. 2a and FIG. 2b are sectional planes through individual spheres from the section shown. Some of them do not pass through the center of the respective spheres. This creates the distorting optical impression that the sphere packing is not bidisperse.

Table 2 shows three particularly suitable filter media 3₁, 3₂ and 3₃ with bidisperse sphere packings.

TABLE 2
Properties of three particularly suitable filter media

| | | | | | | | Packing |
|---|---|---|---|---|---|---|---|
| | d₁ | d₂ | p₁ | p₂ | | | density |
| Configuration | (mm) | (mm) | (%) | (%) | k_{d} | kₚ | (vol %) |
| 3_{1′} | 1.0 | 0.300 | 0.667 | 0.333 | 0.300 | 0.50 | 72 |
| 3_{2′} | 1.0 | 0.25 | 0.625 | 0.375 | 0.250 | 0.60 | 73 |
| 3_{3′} | 1.0 | 0.225 | 0.625 | 0.375 | 0.225 | 0.60 | 74 |

In configuration 3₁, for example, a filter efficiency of >99.0% was achieved at a filter medium length of 8.0 cm, i. e. its size in the flow direction, meaning that more than 99.0% of plastic particles (in this case: polyethylene) with a size between 250 nm and 10 μm were removed from the water flowing through a filter with this filter medium. A flow rate of 0.02 m/s was reached at a volume flow of 6.5 l/min.

The filter medium has a cylindrical shape with a diameter of 9 cm.

The following examples describe various options for coating SiO₂ spheres:

### EXAMPLE 1

In order to produce a filter medium from spheres positioned in a bidisperse sphere packing, SiO₂ spheres with a diameter of 1.00 mm and 0.30 mm are placed in a so-called piranha solution (3 parts concentrated sulfuric acid and 1 part 30% by weight hydrogen peroxide solution) for 60 minutes and then rinsed with distilled water, followed by acetone and ethanol. The drying process takes place at 130° C. and lasts 60 minutes. In order to coat the spheres with a layer that contains polyethylene glycol (PEG), the dried spheres are placed in a solution prepared by mixing 3.54 g of polyethylene glycol in 1.0 l of toluene with 0.9 g triethylamine (TEA), which acts as a catalyst, and treated with ultrasound for 5 minutes. The spheres are then taken out of the ultrasound bath, rinsed with distilled water and dried for 60 minutes at 130° C.

Such a coating is hydrophilic and suitable, for example, to remove polycarbonate (PC) or polyamide (PA) particles from water.

### EXAMPLE 2

In order to produce a filter medium from spheres positioned in a bidisperse sphere packing, SiO₂ spheres with a diameter of 1.0 mm and 0.225 mm are rinsed with ethanol, dichloromethane and deionized water for cleaning.

Polytetrahydrofuran (THF) is then mixed with dichloromethane at a ratio of 1:1 and vortexed. This mixture is then mixed with 7 vol. % trifluoroacetic acid (depending on the volume of the mixture) and the cleaned spheres are placed in it for 10 minutes for coating. The coated spheres are then cleaned with ethanol and dried for 30 minutes at 130° C.

Such a coating has an electrical dipole moment and is suitable, for example, to remove polycarbonate (PC) and polyamide (PA).

1. Filter for the removal of micro- or nanoscale plastic particles from water, which contains a filter medium through which the water can flow, characterized in that the filter medium contains spheres, that the spheres are coated with a layer that is designed to absorb plastic particles and that the spheres are positioned in a bidisperse sphere packing.

2. Filter according to claim 1, characterized in that the packing density of the spheres ranges between 55 and 90 vol %, preferably between 65 and 80% vol, most preferably between 71 vol % and 76 vol %.

3. Filter according to claim 1, characterized in that the ratio k_{d} of the first diameter d₂ of the spheres to the second diameter d₁ of the spheres ranges between 0.10 and 0.35, preferably between 0.20 and 0.31, most preferably is 0.3.

4. Filter according to claim 1, characterized in that the diameter d₁ of the spheres is larger than the diameter d₂ of the spheres and ranges between 0.95 and 1.05 mm, preferably between 0.98 and 1.02 mm, most preferably is 1.0 mm.

5. Filter according to claim 1, characterized in that the ratio kₚ of the volume fraction p₂ of the spheres to the total sphere volume in the filter medium to the volume fraction p₁ of the spheres to the total sphere volume in the filter medium ranges between 0.4 and 0.9, preferably between 0.45 and 0.70, most preferably between 0.49 and 0.61.

6. Filter according to claim 1, characterized in that the length of the filter medium in the direction of the flow through the filter ranges between 3 and 12 cm, preferably between 4 and 10 cm, most preferably is 8 cm or 9 cm.

7. Filter according to claim 1, characterized in that the volume flow at which the water can flow through the filter ranges between 4 and 15 l/min, preferably between 7 and 12 l/min.

8. Filter according to claim 1, characterized in that the spheres contain a material whose surface can be activated, preferably silicon dioxide.

9. Filter according to claim 1, characterized in that the layer is made of a hydrophobic or hydrophilic material, in particular of a hydrophobic or hydrophilic material selected from the group consisting of trichlorosilane, cellulose, polyamide and polyethylene glycol, or that the layer is made of a material that has an electrical dipole moment and is selected from the group consisting of polytetrahydrofuran, polymethyl methacrylate and a zeolite.

10. Filter according to claim 1, characterized in that the layer contains a material that has a conjugated π-system and is preferably selected from the group consisting of activated carbon, graphene, organic zeolites and polycyclic aromatic hydrocarbons.

11. Filter according to claim 1, characterized in that the filter medium consists of several sections which are positioned one after the other in the direction of the flow through the filter and that each section is designed to remove certain plastic particles from the water.

12. Filter according to claim 11, characterized in that the spheres from adjacent sections are coated with different layers.

13. A water treatment device, in particular for the removal of micro- or nanoscale plastic particles from water, comprising a filter according to claim claims 1.

14. Water treatment device according to claim 13, characterized in that the device can be operated by gravitational pressure or by the line pressure of a water pipe from a building.
